(19) United States
(12) Patent Application Publication
(10) Pub. No.: US 2013/0153262 A1
(43) Pub. Date: Jun. 20, 2013

(54) POLYESTER IMIDE RESIN BASED VARNISH FOR LOW-PERMITTIVITY COATING FILM

(71) Applicants: Hideaki Saito, Osaka-shi (JP); Yuudai Furuya, Osaka-shi (JP); Kengo Yoshida, Koka-shi (JP); Yuji Hatanaka, Koka-shi (JP)

(72) Inventors: Hideaki Saito, Osaka-shi (JP); Yuudai Furuya, Osaka-shi (JP); Kengo Yoshida, Koka-shi (JP); Yuji Hatanaka, Koka-shi (JP)

(73) Assignee: SUMITOMO ELECTRIC INDUSTRIES, LTD., OSAKA-SHI, OSAKA (JP)

(21) Appl. No.: 13/818,924

(22) PCT Filed: Aug. 23, 2011
(86) PCT No.: PCT/JP2011/068902

§ 371 Date: Feb. 25, 2013

(30) Foreign Application Priority Data
Aug. 24, 2010 (JP) 2010-186880
Sep. 1, 2010 (JP) 2010-195481
Sep. 10, 2010 (JP) 2010-202687

(51) Int. Cl. H01B 3/30; H01B 3/36

(52) U.S. Cl. CPC H01B 3/306; H01B 3/36
USPC 174/110 SR; 524/602

(57) ABSTRACT

Provided are a varnish mainly containing a polyester imide and capable of forming a low-permittivity insulating layer, as well as an insulated electronic wire achieving low permittivity by using the varnish. The varnish mainly contains a polyester imide resin obtained by reacting a carboxylic acid including a dicarboxylic acid, or an anhydride or alkyl ester thereof (carboxylic acid or derivative thereof), an alcohol, and a diamine compound with one another. In the varnish, adjustment is made such that a molar ratio (OH/COOH) of hydroxyl groups of the alcohol to carboxyl groups of the carboxylic acid or derivative thereof becomes 1.9 or less or such that a content of highly polarized imide groups per unit amount of polyester imide chain is reduced by increasing molecular weights of the raw material monomers.

### TECHNICAL FIELD

The present invention relates to a polyester imide resin based varnish and an insulated electric wire employing the polyester imide resin based varnish, more particularly, a varnish for forming a polyester imide based insulating coating film having a high partial discharge (corona discharge) inception voltage, as well as an insulated electric wire having the insulating coating film.

### BACKGROUND ART

In an electric device fed with high applied voltage such as a motor used under high voltage, an insulated electric wire included in the electric device is fed with high voltage, and partial discharge (corona discharge) is likely to occur at a surface of an insulating coating film of the insulated electric wire. The occurrence of the corona discharge causes local temperature rise and generation of ozone or ions. This results in damage in the insulating coating film and dielectric breakdown at an early stage, which leads to short lives of the insulated electric wire and the electric device, disadvantageously.

Insulating coating films of insulated electric wires are required to achieve excellent insulating property, excellent adhesion property to a conductor, high heat resistance, high mechanical strength, and the like. In addition to these, the insulated electric wire used in the electric device fed with high applied voltage is required to achieve improved corona inception voltage due to the reason described above.

A method to increase the corona inception voltage is to provide an insulating layer with low permittivity. For example, it is known that when the insulating layer is formed of a material such as a polyimide resin or a fluororesin, each of which has low permittivity, the corona inception voltage can become high. Meanwhile, Patent Literature 1 (Japanese Patent Laying-Open No. 2009-277369) discloses an insulated electric wire in which a mixed resin of polyester imide and polyether sulfone is used for an insulating layer.

### CITATION LIST

### Patent Literature

PTL 1: Japanese Patent Laying-Open No. 2009-277369

### SUMMARY OF INVENTION

### Technical Problem

The method of using the low-permittivity material for the insulating layer is effective for improvement of the corona inception voltage, but the insulating layer also needs to satisfy the requirements with regard to insulating property, adhesion property to a conductor, heat resistance, and mechanical strength. Further, material cost is also an important factor in selecting the material.

The polyimide resin has low permittivity, excellent heat resistance, excellent mechanical strength, and the like, but is a high-cost material, which makes the insulated electric wire expensive. The fluororesin has low permittivity but is soft and inferior in heat resistance and mechanical strength. Hence, when used as an insulating layer, purpose of use thereof is limited. In the insulating material described in Patent Literature 1, the permittivity and the mechanical property are balanced. However, an engineering thermoplastic such as polyether sulfone is not thermally set and is therefore inferior in heat resistance. Hence, the property may be insufficient depending on purpose of use thereof.

The present invention has been made in view of such a circumstance, and has its object to provide a varnish mainly containing polyester imide and capable of forming a low-permittivity insulating layer, as well as an insulated electric wire having low permittivity achieved by using the varnish.

### Solution to Problem

The present inventors have conducted various analyses on polyester imide resins, and has found that low permittivity can be achieved by adjusting composition of raw material monomers. With further analysis conducted, the present inventors have found that the permittivity of a polyester imide resin film can be effectively decreased by decreasing a ratio of highly polarized imide groups contained in a polyester imide chain, and has completed the present invention.

Specifically, a polyester imide resin based varnish for a low-permittivity coating film in the present invention mainly contains a polyester imide resin obtained by reacting a carboxylic acid including a dicarboxylic acid, or an anhydride or alkyl ester thereof (hereinafter, collectively referred to as “carboxylic acid or derivative thereof”), an alcohol, and a diamine compound with one another, wherein monomer composition is adjusted such that a total molecular weight of the diamine compound and the dicarboxylic acid (in the case where each of the diamine and the dicarboxylic acid is composed of a plurality of components, a total molecular weight calculated using a diamine compound and a dicarboxylic acid both having the maximum molecular weights) becomes 368 or more, or a molar ratio (OH/COOH) of a hydroxyl group of the alcohol to a carboxyl group of the carboxylic acid or derivative thereof becomes 1.9 or less.

The carboxylic acid or derivative thereof may include a dicarboxylic acid having a molecular weight of 167 or more, or an anhydride or alkyl ester thereof. The diamine compound may include a diamine compound having a molecular weight of 250 or more. The carboxylic acid or derivative thereof may include a dicarboxylic acid having a molecular weight of 167 or more, or an anhydride or alkyl ester thereof, and the diamine compound may include a diamine compound having a molecular weight of 250 or more.

In the above cases, the dicarboxylic acid is preferably naphthalenedicarboxylic acid or cyclohexanedicarboxylic acid. The diamine compound is preferably a diamine compound containing no fluorine atom.

Further, a molar ratio (OH/COOH) of a hydroxyl group of the alcohol to a carboxyl group of the carboxylic acid or derivative thereof is preferably 1.2 to 2.7. A ratio (imide/ester) of a content of an imide acid portion to a content of the ester portion is preferably 0.2 to 1.0.

Further, another embodiment of the polyester imide resin based varnish for the low-permittivity coating film in the present invention mainly contains a polyester imide resin obtained by reacting a carboxylic acid including a dicarboxylic acid, or an anhydride or alkyl ester thereof (hereinafter, collectively referred to as “carboxylic acid or derivative thereof”), an alcohol, and a diamine compound with one another, wherein monomer composition is adjusted such that a molar ratio (OH/COOH) of a hydroxyl group of the alcohol to a carboxyl group of the carboxylic acid or derivative thereof becomes 1.9 or less.

In this case, a ratio (imide/ester) of a content of an imide acid portion to a content of an ester portion is preferably 0.32 or more. The alcohol is preferably a mixed alcohol containing ethylene glycol (EG) and tris(2-hydroxyethyl)isocyanurate (THEIC) at a ratio of THIEC/EG=0.5 to 4.0.

The polyester imide resin based varnish for the low-permittivity coating film in the present invention may further contain a phenol resin or analog thereof.

An insulated electric wire in the present invention includes an insulating coating film obtained by applying the above-described varnish of the present invention onto a conductor and baking the varnish.

### Advantageous Effects of Invention

With the increased molecular weight(s) of the dicarboxylic acid and/or the diamine compound of the raw material monomers, the content of imide groups per polyester imide chain can be made low. By reducing the content of the highly polarized imide groups, or by adjusting the blending ratio of the monomers to fall within the specific range, the permittivity of the polyester imide resin coating film can be decreased.

### BRIEF DESCRIPTION OF DRAWINGS

FIG. 1 illustrates a method for measuring permittivity.

FIG. 2 is a graph showing a relation between the molecular weight of a diamine and the permittivity.

FIG. 3 is a graph showing a relation between the permittivity and the molecular weight of a dicarboxylic acid used in Example.

FIG. 4 is a graph showing a relation between the permittivity and the total molecular weight of the diamine and the dicarboxylic acid used in Example.

FIG. 5 is a graph showing a relation between an excess hydroxyl group ratio and the permittivity.

FIG. 6 is a graph showing a relation between an imide/ester ratio and the permittivity.

### DESCRIPTION OF EMBODIMENTS

The following describes embodiments of the present invention but the embodiments disclosed herein are illustrative and non-restrictive in any respect. The scope of the present invention is defined by the terms of the claims, and is intended to include any modifications within the scope and meaning equivalent to the terms of the claims.

[Polyester Imide Resin Based Varnish and Method for Producing Same]

Described first is synthesis of a polyester imide resin used for a polyester imide resin based varnish of the present invention.

<Polyester Imide Resin>

The polyester imide resin refers to a resin having ester bonds and imide bonds in a molecule, and is formed by an ester formation reaction in which an imide formed of a polyvalent carboxylic acid or a anhydride thereof and an amine, a polyester formed of an alcohol and a carboxylic acid, and a free acid group or an anhydride group of the imide are involved. Such a polyester imide resin is synthesized under conditions that imidification, esterification, and transesterification can take place.

The polyester imide resin used in the present invention mainly contains polyester imide obtained by reacting a carboxylic acid including a dicarboxylic acid, or an anhydride or alkyl ester thereof (hereinafter, collectively referred to as “carboxylic acid or derivative thereof”), an alcohol, and a diamine compound with one another. Types and blending ratio of the raw material monomers (the carboxylic acid or derivative thereof, the alcohol, and the diamine compound) are adjusted to achieve permittivity lower than permittivity of a coating film obtained from a generally available ester imide based varnish (approximately 3.8 when a coating film having a thickness of 1 mm is formed on a copper wire). Specifically, such permittivity can be achieved by adjusting a molar ratio (OH/COOH) of the hydroxyl groups of the alcohol to the carboxyl groups of the carboxylic acid or derivative thereof, or by using a diamine compound and/or a dicarboxylic acid that allow(s) for a larger total molecular weight of the diamine compound and dicarboxylic acid than the total molecular weight (274 to 367) of the diamine compound and dicarboxylic acid used in the generally available polyester imide resin varnish.

In the case where a plurality of types of components are included as each of the diamine compound and the dicarboxylic acid, the above-described total molecular weight refers to a total molecular weight calculated based on a diamine compound and a dicarboxylic acid each having the maximum molecular weight.

Thus, as the polyester imide resin used for the polyester imide resin based varnish for the low-permittivity coating film in the present invention, the following specific embodiments are exemplified: (a) a polyester imide resin in which the monomer composition is adjusted such that the molar ratio (OH/COOH) of the hydroxyl groups of the alcohol to the carboxyl groups of the carboxylic acid or derivative thereof becomes 1.9 or less; (b) a polyester imide resin in which a carboxylic acid including a dicarboxylic acid having a molecular weight of 167 or more, or an anhydride or alkyl ester thereof is used as the carboxylic acid or derivative thereof; (c) a polyester imide resin in which a diamine compound including a diamine having a molecular weight of 250 or more is used; (d) a polyester imide resin in which a carboxylic acid including a dicarboxylic acid having a molecular weight of 167 or more, or an anhydride or alkyl ester thereof is used as the carboxylic acid or derivative thereof, and in which a diamine having a molecular weight of 250 or more is included as the diamine compound (hereinafter, these embodiments may be referred to as embodiment (a), embodiment (b), and the like).

The following describes the monomer components in the polyester imide resin used in the present invention.

(1) Carboxylic Acid or Derivative Thereof

In addition to terephthalic acid and isophthalic acid both having been conventionally used, examples usable as the dicarboxylic acid include: dicarboxylic acids of polynuclear aromatic hydrocarbons, which have a molecular weight of 167 or more; phthalic acids containing alkyl groups, which have a molecular weight of 167 or more; dicarboxylic acids of alicyclic hydrocarbons having carbon number 6 or more, which have a molecular weight of 167 or more; and the like. Examples of the dicarboxylic acids of polynuclear aromatic hydrocarbons include a naphthalenedicarboxylic acid, an anthracenedicarboxylic acid, and a phenanthrenedicarboxylic acid. Examples of the naphthalenedicarboxylic acid include 1,2-naphthalenedicarboxylic acid, 1,3-naphthalenedicarboxylic acid, 1,4-naphthalenedicarboxylic acid, 1,5-naphthalenedicarboxylic acid, 1,6-naphthalenedicarboxylic acid, 1,7-naphthalenedicarboxylic acid, 1,8-naphthalenedicarboxylic acid, 2,3-naphthalenedicarboxylic acid, 2,6-naphthalenedicarboxylic acid, 2,7-naphthalenedicarboxylic acid, and the like. Examples of the phthalic acids containing alkyl groups include 2-methyl-1,4-benzenedicarboxylic acid, and the like. Examples of the dicarboxylic acids of alicyclic hydrocarbons having carbon number 6 or more include 1,2-cyclohexanedicarboxylic acid, 1,3-cyclohexanedicarboxylic acid, 1,4-cyclohexanedicarboxylic acid, 2,3-norbornanedicarboxylic acid, and the like. Each of these dicarboxylic acids may be used as alkyl ester or acid anhydride.

In the case where the above-described embodiment (b) or (d) is employed for the polyester imide resin based varnish, a dicarboxylic acid having a molecular weight of 167 or more is used. In this case, in view of reactivity, a naphthalenedicarboxylic acid is preferably used. More preferably, the 2,6-naphthalenedicarboxylic acid is used.

By using a dicarboxylic acid having a molecular weight larger than the molecular weight (166) of a phthalic acid, a ratio of imide groups contained per unit molecular weight in a polyester imide chain to be synthesized can be made small. Because the imide groups are highly polarized, permittivity of the polyester imide film can be decreased by reducing the content of the imide groups in the polyester imide.

It should be noted that even in the case where a dicarboxylic acid having a molecular weight of 167 or more is used, an anhydride of another polycarboxylic acid, a dicarboxylic acid having a molecular weight of 166 or less, or an alkyl ester thereof may be included. However, in order to obtain the effect of achieving low permittivity by blending a dicarboxylic acid having a molecular weight of 167 or more, the dicarboxylic acid having a molecular weight of 167 or more is preferably contained by 10 mol % to 100 mol % relative to the dicarboxylic acid or derivative thereof.

As the above-described anhydride of another polycarboxylic acid, the following can be used: a compound in which two acyl groups share one oxygen atom due to one molecule of water being lost from two carboxyl groups; or a compound having one or more free carboxyl groups left. Examples thereof include trimellitic anhydride, 3,4,4′-benzophenone tricarboxylic anhydride, 3,4,4′-biphenyl tricarboxylic anhydride, and aromatic tetracarboxylic dianhydrides such as biphenyl tetracarboxylic dianhydride, benzophenone tetracarboxylic dianhydride, diphenyl sulfone tetracarboxylic dianhydride, oxydiphthalic dianhydride (OPDA), pyromellitic dianhydride (PMDA), and 4,4′-(2,2-hexafluoroisopropylidene)diphthalic dianhydride (6FDA). Among these, trimellitic anhydride (TMA) is preferably used.

(2) Diamine Compound

As the diamine compound, a diamine compound conventionally used in the field of polyester imide resin based varnish can be used. Specifically, 4,4′-methylenediphenyldiamine (MDA) (Mw=198.26), 4,4′-diaminodiphenyl ether (Mw=200.24) or p-phenylenediamine (Mw=108.14) can be used. Also, a diamine compound (preferably, aromatic diamine) having a molecular weight of 250 or more can be used.

In the case where the above-described embodiment (c) or (d) is employed for the polyester imide resin based varnish, a diamine having a molecular weight of 250 or more is used in at least a part of the used diamine compound, preferably is used by 50 mol % or more, more preferably 80 mol % or more, further preferably 100 mol %. As with the dicarboxylic acid, by using a diamine having a large molecular weight for at least a part of the raw material monomers of the polyester imide, the content of the imide groups per unit molecular weight in the polyester imide chain to be synthesized can be decreased. In particular, when used in combination with a dicarboxylic acid having a molecular weight of 167 or more, the effect of reducing the content of the imide groups per polyester imide chain can be larger than that in the case where a dicarboxylic acid having a large molecular weight is used solely or a diamine having a large molecular weight is used solely.

Examples of such a diamine compound having a molecular weight of 250 or more include 1,3-bis(4-aminophenoxy)benzene (Mw=292.33), 4,4′-bis(4-aminophenoxy)biphenyl (Mw=368.43), 1,1-bis{4-(4-aminophenoxy)phenyl}cyclohexane (Mw=450.59), 1,4-bis(4-aminophenoxy)naphthalene (Mw=342.40), 1,3-bis(4-aminophenoxy)adamantane (Mw=350.45), 2,2-bis{4-(4-aminophenoxy) phenyl}propane (Mw=410.51), 2,2-bis{4-(4-aminophenoxy)phenyl}hexafluoropropane (Mw=518.45), bis{4-(4-aminophenoxy)phenyl}sulfone (Mw=432.49), 4,4′-diamino-2,2′-bis(trifluoromethyl)diphenyl ether (Mw=336.23), bis{4-(4-aminophenoxy)phenyl}ketone (Mw=396.44), 1,4-bis(4-aminophenoxy)2,3,5-trimethylbenzene (Mw=334.41), 1,4-bis(4-aminophenoxy)2,5-di-t-butylbenzene (Mw=404.54), 1,4-bis{4-amino-2-(trifluoromethyl)phenoxy}benzene (Mw=428.33), 2,2-bis[4-{4-amino-2-(trifluoromethyl)phenoxy}phenyl]hexafluoropropane (Mw=654.45), 4,4′-diamino-2-(trifluoromethyl)diphenyl ether (Mw=268.23), 1,3-bis(4-aminophenoxy)neopentane (Mw=286.37), 2,5-bis(4-aminophenoxy)biphenyl (Mw=368.43), 9,9′-bis(4-aminophenyl)fluorene (Mw=348.44), and the like. Each of them can be used solely or two or more of them can be used in combination.

Among the diamine compounds each having a molecular weight of 250 or more, a diamine compound having a molecular weight of 250 to 600 is preferable, and a diamine compound having a molecular weight of 300 to 550 is more preferable. As the molecular weight of the diamine used as a component for forming polyester imide is larger, the molecular weight of an ester imide unit to be formed becomes larger. This means that the ratio of imide groups per unit molecular weight in the polyester imide resin (concentration of the imide groups in the polymer chain) is small. It is considered that the decrease of the concentration of the highly polarized imide groups per polyester imide chain causes decrease of permittivity. On the other hand, when the molecular weight thereof exceeds 600, the effect of contributing to the reduction of the permittivity by the decrease of the concentration of the imide groups tends to be small.

Further, among the diamine compounds each having a molecular weight of 250 or more, a compound containing no fluorine atom is preferable in view of cost and availability. A diamine compound containing a fluorine atom tends to provide a larger effect of reducing the permittivity than the effect provided by a diamine compound having a similar molecular weight. However, in view of cost and availability, the diamine compound containing a fluorine atom is unlikely to be employed as the material for the polyester imide resin based varnish. To address this, by using the compound containing no fluorine atom together with a dicarboxylic acid having a large molecular weight, the permittivity can be reduced as small as permittivity reduced when using the diamine containing a fluorine atom.

(3) Alcohol

Examples of the alcohol include: divalent alcohols such as ethylene glycol, neopentylglycol, 1,4-butanediol, 1,6-hexanediol, and 1,6-cyclohexanedimethanol; trivalent or higher-valent alcohols such as glycerine, trimethylolpropane, and pentaerythritol; alcohols having an isocyanurate ring; and the like. Examples of the alcohols having the isocyanurate ring include tris(hydroxymethyl)isocyanurate, tris(2-hydroxyethyl)isocyanurate (THEIC), tris(3-hydroxypropyl)isocyanurate, and the like. Each of these polyvalent alcohols may be used solely or two or more of them may be used in combination. However, in order to provide heat resistance, it is preferable to use a combination of an alcohol having an isocyanurate ring and a lower alcohol. It is more preferable to use a combination of THEIC and ethylene glycol. Further preferably, the THEIC and the ethylene glycol are combined such that a molar ratio (THEIC/EG) of OH groups of the THEIC to OH groups of the ethylene glycol (EG) becomes 0.5 to 4.0.

(4) Other Monomers

As a raw material monomer for the polyester imide resin used in the present invention, apart from the above-described carboxylic acid or derivative thereof, the diamine compound, and the alcohol, a diisocyanate may be contained to such an extent that the effect of the present invention is not hindered (specifically, 5% by mass or less, preferably, 1% by mass or less of the monomers).

Examples of the diisocyanate include aromatic diisocyanates such as diphenylmethane-4,4′-diisocyanate (MDI), diphenylmethane-3,3′-diisocyanate, diphenylmethane-3,4′-diisocyanate, diphenyl ether-4,4′-diisocyanate, benzophenone-4,4′-diisocyanate, diphenylsulfone-4,4′-diisocyanate, tolylene-2,4-diisocyanate, tolylene-2,6-diisocyanate, naphtylene-1,5-diisocyanate, m-xylylene diisocyanate, p-xylylene diisocyanate, and the like. Each of these diisocyanates can react with the carboxylic acid or derivative thereof and can be involved in reaction for forming amide and imide.

A method for producing the polyester imide using the above-described polyester imide raw material monomers is not particularly limited. Examples of the method include: (1) a method in which imidification and esterification are performed simultaneously by collectively introducing the polyester imide raw material monomers (the carboxylic acid or derivative thereof, the diamine, and the alcohol); and (2) a method in which the polyester components other than the imide acid component are reacted in advance, and then imidification is performed by adding the imide acid component.

Of the above-described production methods, it is preferable to use the method (1) in view of its simplicity for the synthesis.

The reaction for synthesizing the polyester imide may be performed in presence of an organic solvent such as cresol, or in absence of a solvent. When an imidedicarboxylic acid is generated, viscosity in the synthesis system becomes high. Hence, in order to facilitate control in the system, the synthesis is preferably performed in presence of a solvent. Meanwhile, in the synthesis of the polyester imide resin in absence of a solvent, the polyester imide raw material monomers exist at high concentration in the system. Accordingly, faster reaction and larger molecular weight can be expected.

In the blend composition of the polyester imide raw material monomers, a molar ratio (OH/COOH) (hereinafter, this ratio may be referred to as “excess hydroxyl group ratio”) of the hydroxyl groups to the carboxyl groups is not particularly limited and the blending can be performed such that this ratio falls within a range of 1.2 to 2.7, in the case of the embodiments (b), (c), and (d) in each of which the monomers are used such that the total molecular weight of the diamine compound and the dicarboxylic acid becomes 368 or more. Preferably, the ratio is 1.2 or more and less than 2, more preferably, 1.2 to 1.9. As the OH/COOH is increased, the permittivity tends to be higher. Hence, by setting the OH/COOH to 1.9 or less, a greater effect of reducing the permittivity can be achieved.

Particularly, by using a diamine compound having a molecular weight of 250 or more (embodiment (c)) or a dicarboxylic acid having a molecular weight of 167 or more (embodiment (b)), the permittivity can be less than 3.6, preferably, 3.5 or less.

Further, in the embodiment (d), by using both a dicarboxylic acid and a diamine compound each having a large molecular weight, the content of the imide groups per unit molecular weight in the polyester imide chain can be further reduced as compared with a case where only one of the dicarboxylic acid and the diamine compound has a large molecular weight. This makes it possible to achieve low permittivity, such as a permittivity of 3.3 or less, which is difficult to attain when the dicarboxylic acid is solely used or when the diamine compound containing no fluorine is solely used. In particular, when such a readily available diamine compound is used together with a readily available dicarboxylic acid such as naphthalenedicarboxylic acid or cyclohexanedicarboxylic acid, the content of the imide groups can be efficiently reduced. This makes it possible to achieve a permittivity of 3.2 or less, which is difficult to attain in production in which a diamine monomer having a large molecular weight is solely used.

It should be noted that even in the case where phthalic acid is used as the dicarboxylic acid and 4,4′-methylenediphenyldiamine (MDA) is used as the diamine compound, permittivity lower than ε (permittivity) (approximately 3.8) of a generally available ester imide, i.e., permittivity (ε) of 3.7 or less can be achieved by adjusting the excess hydroxyl group ratio, specifically, by setting the OH/COOH to 1.9 or less (embodiment (a)).

The amount of hydroxyl groups herein is an amount of hydroxyl groups contained in the alcohol, and can be calculated as an amount obtained by multiplying the blending amount (moles) by the number of functional groups. For example, ethylene glycol has two OH groups in one molecule, so that the amount of hydroxyl groups is calculated to be 2 moles. THEIC has three OH groups in one molecule, so that the amount of hydroxyl groups is calculated to be 3 moles.

The amount of carboxyl groups is an amount of carboxyl groups contained in the dicarboxylic acid, the alkyl ester thereof, or the carboxylic anhydride, each of which is the carboxylic acid or derivative thereof. The amount of carboxyl groups is calculated as an amount obtained by multiplying the blending amount (moles) by the number of functional groups. For the dicarboxylic acid, the amount of carboxyl groups is calculated to be 2 moles. Even when the carboxyl groups are formed into ester, the calculation is performed while handling it in a manner equivalent to the dicarboxylic acid. Meanwhile, in the case of the acid anhydride, the amount of carboxyl groups is calculated assuming that only an amount of free carboxyl groups is the amount of acid. For example, in the case of trimellitic anhydride, the amount of carboxyl groups is calculated to be 1 mole.

Further, in the blend composition of the polyester imide raw material monomers, the molar ratio (imide/ester) of imide bonds to ester bonds in the polyester imide to be obtained is not particularly limited. The blending may be performed such that the molar ratio falls within a range of approximately 0.2 to 1.0, which is a range of imide/ester ratio in a conventional polyester imide. Preferably, the molar ratio is 0.32 to 1.0. Preferably, the blending is performed such that the molar ratio falls within a range of 0.4 to 1.0. When the ratio of the content of the imide in the polyester imide to be synthesized becomes too large, an electric wire to be fabricated will have poor adhesion property. When the ratio of the content of the imide therein becomes too small, flexibility and heat shock will be decreased.

In the conventional polyester imide, the imide/ester ratio is approximately 0.2 to 0.4. The present inventors have found that by increasing the imide/ester ratio, the permittivity tends to be decreased. In view of this, in addition to setting the OH/COOH to 1.9 or less, the imide/ester is set to 0.32 or more, preferably 0.4 to 1.0, thereby readily attaining permittivity (specifically, 3.7 or less, or 3.6 or less, preferably 3.5 or less), which is lower than the permittivity (normally, approximately 3.8) of a generally available ester imide.

Here, the amount of imide is a molar ratio of imide acid synthesized from the acid anhydride and the diamine compound, and is calculated as an amount obtained by multiplying the blending amount of the diamine (number of moles) by the number of functional groups (that is, 2).

Further, the amount of ester is calculated as the amount of carboxylic acid. Therefore, the amount of ester is equal to the amount of carboxyl groups, which was calculated for the above-described excess hydroxyl group ratio.

In the synthesis of the polyester imide resin used in the present invention, in addition to the raw material monomers, a titanium-based compound, such as tetrabutyl titanate (TBT) or tetrapropyl titanate (TPT), is used as a catalyst. A titanium alkoxide such as tetrapropyl titanate, tetraisopropyl titanate, tetramethyl titanate, tetrabutyl titanate, or tetrahexyl titanate is preferably used. The catalyst is preferably blended by 0.01 parts by mass to 0.5 parts by mass per 100 parts by mass of the polyester imide raw material monomers (blended by 0.01% by mass to 0.5% by mass of the resin to be synthesized).

The polyester imide raw material monomers are introduced into the system in the manner described above, and are heated at 80° C. to 250° C. for reaction. The order of blending the polyester imide raw material monomers is not particularly limited, and they may be collectively introduced into the system. The reaction of the raw material monomers may be performed in presence or in absence of a solvent. In the case where the reaction is performed in presence of a solvent, the raw material monomers are diluted by the solvent and thereafter heating is performed at 80° C. to 250° C. for the reaction.

Completion of the reaction can be known by checking for correspondences with values, calculated from the blended monomers, of amounts of water to be distilled off and resin.

The polyester imide resin thus synthesized is diluted with an organic solvent, and then a curing agent and other additives are added to produce a polyester imide varnish.

<Organic Solvent>

As the solvent for the dilution, a known organic solvent having been conventionally used for a polyester imide varnish can be used. Specifically, an organic solvent capable of dissolving a polyester imide resin can be used, such as N-methyl pyrrolidone, cresylic acid, m-cresol, p-cresol, phenol, xylenol, xylene, or a cellosolve. The dilution by the organic solvent is performed such that non-volatile components (solid content) are of 40% by mass to 50% by mass.

<Curing Agent>

As the curing agent, a titanium-based curing agent, a block isocyanate, or the like can be used.

Examples of the titanium-based curing agent include tetrapropyl titanate, tetraisopropyl titanate, tetramethyl titanate, tetrabutyl titanate, tetrahexyl titanate, and the like. Each of these titanium-based curing agents may be used solely, or may be blended in advance, as a mixed liquid, with an organic solvent used for the varnish.

Examples of the block isocyanate include diphenylmethane-4,4′-diisocyanate (MDI), diphenylmethane-3,3′-diisocyanate, diphenylmethane-3,4′-diisocyanate, diphenyl ether-4,4′-diisocyanate, benzophenone-4,4′-diisocyanate, diphenylsulfone-4,4′-diisocyanate, tolylene-2,4-diisocyanate, tolylene-2,6-diisocyanate, naphtylene-1,5-diisocyanate, m-xylylene diisocyanate, p-xylylene diisocyanate, and the like. Among these, it is preferable to use a compound having an isocyanuric ring to provide heat resistance. Specifically, CT stable, BL-3175, TPLS-2759, BL-4165, or the like provided by Sumitomo Bayer Urethane Co., Ltd. can be used.

<Other Components>

In the production of the polyester imide resin based varnish of the present invention, in order to improve properties required for the varnish such as heat resistance and flexibility, a phenol resin or analog thereof such as a phenol resin, a xylene resin, or a phenol modified xylene resin, a phenoxy resin, a polyamide resin, a polyamide imide resin, or the like may be added as a resin other than the polyester imide resin.

Various types of additives, such as pigment, dye, inorganic or organic filler, and lubricant, may be further added as required. After the addition of these additives, heating may be further performed.

[Insulated Electric Wire]

The insulated electric wire of the present invention employs the above-described polyester imide varnish of the present invention as its insulating coating.

As a conductor, a metal conductor such as copper, a copper alloy wire, or an aluminum wire can be used. The diameter and cross sectional shape of the conductor are not particularly limited, but a conductor having a diameter of 0.4 mm to 3.0 mm can be generally used.

The polyester imide resin based varnish of the present invention is applied onto the surface of the conductor, and is baked to form an insulating coating film. The application and baking can be performed in method and conditions similar to those for formation of an insulating coating film for a conventional insulated electric wire. The application and baking process may be repeated twice or more. Further, the polyester imide resin based varnish of the present invention can be blended with other resin paint(s) to such an extent that the object of the present invention is not spoiled.

The baking of the polyester imide resin based varnish is preferably performed by passing it through a furnace of approximately 300° C. to 500° C. for 2 minutes to 4 minutes.

The insulating coating film preferably has a thickness of 1 μm to 100 μm, more preferably 10 μm to 50 μm in order to protect the conductor. When the insulating coating film is too thick, the outer diameter of the insulated electric wire becomes large, with the result that a space factor of a coil around which the insulated electric wire is wound tends to be decreased.

The insulating coating film of the polyester imide resin based varnish may be directly formed on the conductor, or the insulating coating film of the polyester imide resin may be formed on an underlying layer formed first on the surface of the conductor.

Examples of the underlying layer include insulating films formed through application and baking of various types of conventionally known insulating paints, such as a polyurethane based paint, a polyester based paint, a polyester imide based paint, a polyester amide imide based paint, a polyamide imide based paint, a polyimide based paint, or the like.

Moreover, an overlying layer may be provided on the polyester imide coating film formed using the varnish of the present invention. In particular, by forming a surface lubricating layer on the external surface of the insulated electric wire so as to provide lubricity, stress caused by friction between electric wires during coil winding and pressing for increasing the space factor, as well as damage of the insulating coating film caused by this stress can be preferably reduced. The overlying layer may be composed of any resin as long as it has lubricity. Examples thereof include a resin obtained by binding a lubricant with a binder resin. Examples of the lubricant include: paraffins such as liquid paraffin and solid paraffin; various types of waxes; polyethylene; a fluororesin; a silicone resin; and the like. Preferably, an amide imide resin provided with lubricity by addition of a paraffin or a wax is used.

### EXAMPLE

The following describes the best mode for implementing the present invention with reference to an example. The example is not intended to limit the scope of the present invention.

### Methods of Measurement and Calculation

Explained first are methods of measurement and calculation performed in the present example.

(1) Measurement of Permittivity (ε)

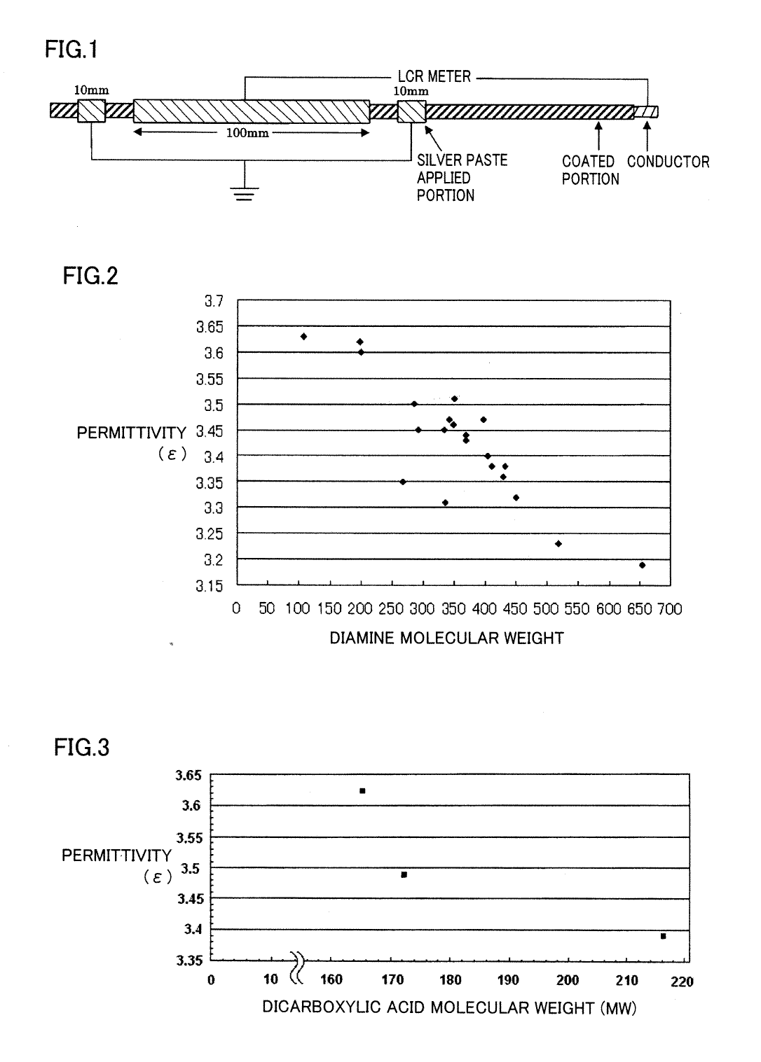

An polyester imide resin based varnish prepared was applied onto each of copper wires (diameter of 1.0 mm), and was baked at a furnace temperature of 450° C., thus fabricating an insulated electric wire insulatively coated with an polyester imide resin layer having a coating film thickness of 35 μm. For each of the obtained insulated electric wires, the permittivity of the insulating layer was measured. The measurement was performed in the following manner. That is, as shown in FIG. 1, silver pastes were applied to three locations on the surface of the insulated electric wire, thereby fabricating a sample for the measurement (the width of each of the applied silver pastes in the two locations at the opposite ends was 10 mm whereas the width of the applied silver paste at the center portion was 100 mm) A capacitance between the conductor and each silver paste was measured using an LCR meter. From the value of the measured capacitance and the thickness of the coating film, the permittivity was calculated.

(2) Excess Hydroxyl Group Ratio (OH/COOH)

Based on the blending amounts of the monomers, an amount of OH and an amount of COOH were calculated from the below-described formulas and the amount of OH/the amount of COOH was calculated.

The amount of OH=the number of moles of ethylene glycol×2+the number of moles of THEIC×3

The amount of COOH=the number of moles of dicarboxylic acid×2+the number of moles of TMA×1

(3) Imide/Ester Ratio

Based on the blending amounts of the monomers, an amount of imide and an amount of ester were calculated from the below-described formulas and an imide/ester ratio was calculated.

The amount of imide=the number of moles of diamine compound×2

The amount of ester=the number of moles of dicarboxylic acid×2+the number of moles of TMA×1

[Relation between Types of Polyester Imide Raw Material Monomers and Permittivity of Insulating Coating Film]

(1) Relation between Molecular Weight of Diamine Compound and Permittivity of Insulating Coating Film

(Preparation of Polyester Imide Resin Varnish (A Series) and Fabrication and Evaluation of Insulated Electric Wire)

As the polyester imide raw material monomers, the carboxylic acid or derivative thereof (trimellitic anhydride (TMA) and terephthalic acid (TPA)), the alcohol (ethylene glycol (EG) and tris(2-hydroxyethyl)cyanurate (THEIC)), and each of diamines having different molecular weights as indicated in No. A1 to No. A21 in Table 2 were respectively blended by amounts (g) shown in Table 1. In addition, as a catalyst, tetrapropyl titanate (TPT) was blended by 1.2 g (corresponding to 0.16% by mass of a stoichiometric amount of the resin to be synthesized). Thereafter, temperature was increased to 80° C., then was further increased from 80° C. to 180° C. in 1 hour, then was further increased from 180° C. to 235° C. in 4 hours, and then was kept at 235° C. for 3 hours.

It should be noted that the amount of blending of each component in Table 1 is an amount for synthesizing 750 g of polyester imide resin. THEIC/EG (molar ratio of OH groups) and excess hydroxyl group ratio (OH/COOH) in the blended monomers, as well as a molar ratio (imide/ester) between imide bonds and ester bonds contained in the synthesized polyester imide resin were calculated as shown in Table 1.

Completion of the reaction was confirmed by confirming that the stoichiometric amount of water calculated from the amounts of the blended monomers coincided with an amount of water generated in the synthesis of the polyester imide resin based on a fact that water is generated in the course of esterification reaction of the carboxylic acid and the hydroxyl groups as well as imidification reaction of the diamine and the anhydride groups.

The polyester imide resin synthesized as described above was diluted to attain a polyester imide resin concentration of 50 mass % by adding a solution in which SCX-1 (product name of Neo Chemical Co., Ltd.; mixed solvent of phenol and cresol) and Swasol #1000 (product name of Maruzen Petrochemical Co., Ltd.; solvent naphtha) were mixed at a ratio of SCX-1/Swasol=80/20.

To the polyester imide resin solution synthesized as above, a TPT (tetrapropyl titanate)/cresol solution (TPT concentration of 63%) obtained by dissolving TPT with cresol was added as a curing agent by an amount (60 g) shown in Table 1. Thereafter, they were mixed at 120° C. for 2 hours. Next, as another resin, phenol modified xylene formaldehyde resin P100 in a solid state was dissolved with an organic solvent SCX-1 (product name of Neo Chemical Co., Ltd.; mixed solvent of phenol and cresol), and the resulting solution was added by an amount (60 g) shown in Table 1. Thereafter, stirring was performed at 70° C. for approximately 1 hour. In this way, polyester imide resin based varnishes No. A1 to No. A21, which were respectively based on the blended diamine compounds No. A1 to No. A21, were prepared. Using polyester imide resin based varnishes No. A1 to No. A21 thus prepared, insulated electric wires No. A1 to No. A21 were fabricated and permittivity of each of insulated electric wires No. A1 to No. A21 was measured based on the above-described measurement method. Results of measurement are shown in Table 2 together with the types of the blended amine compounds. Further, a relation between the molecular weight of each amine compound used and the permittivity is shown in FIG. 2.

TABLE 1

| | | Amount of |
|---|---|---|
| | | Blending (g) |
| Carboxylic Acid | Trimellitic Anhydride | 196 |
| or Derivative Thereof | Terephthalic Acid | 179 |
| Diamine | No. A1 to No. A21 in Table 2 | Molecular |
| | | Weight × 0.51 |
| Alcohol | Ethylene Glycol | 97 |
| | tris-2-hydroxyethyl isocyanate | 253 |
| Additive | TPT-Cresol Solution | 60 |
| | P100 50% SCX-1 Solution | 60 |
| Parameter | OH/COOH | 1.9 |
| | Imide/Ester | 0.32 |
| | THEIC/EG | 0.93 |

TABLE 2

| No | Type of Diamine Compound | Molecular Weight | Permittivity |
|---|---|---|---|
| A1 | 4,4′-methylenediphenyldiamine (MDA) | 198.26 | 3.62 |
| A2 | 4,4′-diaminodiphenyl ether (DPE) | 200.24 | 3.60 |
| A3 | paraphenylenediamine (PPD) | 108.14 | 3.63 |
| A4 | 1,3-bis(4-aminophenoxy)benzene (3-APB) | 292.33 | 3.45 |
| A5 | 4,4′-bis(4-aminophenoxy)biphenyl (4-APBP) | 368.43 | 3.44 |
| A6 | 1,1-bis{4-(4-aminophenoxy)phenyl}cyclohexane (4-APBZ) | 450.59 | 3.32 |
| A7 | 1,4-bis(4-aminophenoxy)naphthalene (4-APN) | 342.40 | 3.47 |
| A8 | 1,3-bis(4-aminophenoxy)adamantane (ADPA) | 350.45 | 3.51 |
| A9 | 2,2-bis{4-(4-aminophenoxy)phenyl}propane (BAPP) | 410.51 | 3.38 |
| A10 | 2,2-bis{4-(4-aminophenoxy)phenyl}hexafluoropropane (HFBAPP) | 518.45 | 3.23 |
| A11 | bis{4-(4-aminophenoxy)phenyl}sulfone (BAPS) | 432.49 | 3.38 |
| A12 | 4,4′-diamino-2,2′-bis(trifluoromethyl)diphenyl ether (BTFDPE) | 336.23 | 3.31 |
| A13 | bis{4-(4-aminophenoxy)phenyl}ketone (BAPK) | 396.44 | 3.47 |
| A14 | 1,4-bis(4-aminophenoxy)2,3,5-trimethylbenzene (TMBAB) | 334.41 | 3.45 |
| A15 | 1,4-bis(4-aminophenoxy)2,5-di-t-butylbenzene (DTBAB) | 404.54 | 3.40 |
| A16 | 1,4-bis{4-amino-2-(trifluoromethyl)phenoxy}benzene (FAPQ) | 428.33 | 3.36 |
| A17 | 2,2-bis[4-{4-amino-2-(trifluoromethyl)phenoxy}phenyl]hexafluoropropane (HFBAPP) | 654.45 | 3.19 |
| A18 | 4,4′-diamino-2-(trifluoromethyl)diphenyl ether (TFDPE) | 268.23 | 3.35 |
| A19 | 1,3-bis(4-aminophenoxy)neopentane (DANPG) | 286.37 | 3.50 |
| A20 | 2,5-bis(4-aminophenoxy)biphenyl (P-TPE-Q) | 368.43 | 3.43 |
| A21 | 9,9′-bis(4-aminophenyl)fluorine (BAPF) | 348.44 | 3.46 |

As understood from FIG. 2, as the molecular weight of the amine compound used for synthesis of the polyester imide resin becomes larger, the permittivity tends to be decreased. Generally, it is understood that by using a diamine compound having a molecular weight larger than that of MDA, which is commonly used as an amine compound, specifically, by using a diamine compound having a molecular weight of 250 or more, the permittivity can become less than 3.6, preferably, 3.5 or less.

Moreover, the permittivity of the resin coating film can be further decreased by introducing low-polarized fluorine substituents, as compared with a case of using a diamine compound having the same molecular weight.

(2) Relation between Types of Dicarboxylic Acid and Permittivity of Insulating

Coating Film

(Preparation of Polyester Imide Resin Based Varnish (C Series) and Fabrication and Evaluation of Insulated Electric Wire)

As the polyester imide raw material monomers, the carboxylic acid or derivative thereof (trimellitic anhydride (TMA) and dicarboxylic acid), the alcohol (ethylene glycol (EG) and tris(2-hydroxyethyl)cyanurate (THEIC)), and the diamine (4,4-methylenediphenyldiamine (MDA)) were blended respectively by amounts (g) shown in Table 3. In addition, as a catalyst, tetrapropyl titanate (TPT) was blended by 1.2 g. Then, temperature was increased to 80° C., then was increased from 80° C. to 180° C. in 1 hour, then was increased from 180° C. to 235° C. in 4 hours, and then was kept at 235° C. for 3 hours.

As the dicarboxylic acid, any one of the followings was used: terephthalic acid (molecular weight of 166: Mitsubishi Gas Chemical Company, Inc.); 2,6-naphthalenedicarboxylic acid (molecular weight of 216: Sumikin Air Water Inc.); and 1,4-cyclohexanedicarboxylic acid (molecular weight of 172: Nikko Rica Corporation). Each of them was blended to finally obtain 750 g of resin by calculating an amount allowing for values, shown in Table 3, of THEIC/EG (molar ratio of OH groups) and excess hydroxyl group ratio (OH/COOH) in the blended monomers, and a molar ratio (imide/ester) between imide bonds and ester bonds contained in the polyester imide resin to be synthesized.

Completion of the reaction was confirmed by confirming that the stoichiometric amount of water calculated from the amounts of the blended monomers coincided with an amount of water generated in the synthesis of the polyester imide resin based on a fact that water is generated in the course of esterification reaction of the carboxylic acid and the hydroxyl groups as well as imidification reaction of the diamine compound and the anhydride groups.

The polyester imide resin synthesized as described above was diluted to attain a polyester imide resin concentration of 50 mass % by adding a solution in which SCX-1 (product name of Neo Chemical Co., Ltd.; mixed solvent of phenol and cresol) and Swasol #1000 (product name of Maruzen Petrochemical Co., Ltd.; solvent naphtha) were mixed at a ratio of SCX-1/Swasol=80/20.

To the polyester imide resin solution synthesized as above, a TPT (tetrapropyl titanate)/cresol solution (TPT concentration of 63%) obtained by dissolving TPT with cresol was added as a curing agent by 60 g. Thereafter, they were mixed at 120° C. for 2 hours. Next, as another resin, phenol modified xylene formaldehyde resin P100 in a solid state was dissolved with an organic solvent SCX-1 (product name of Neo Chemical Co., Ltd.; mixed solvent of phenol and cresol), and the resulting solution was added by 60 g. Thereafter, stirring was performed at 70° C. for approximately 1 hour. In this way, polyester imide resin based varnishes No. C1 to No. C3, in which the types of the blended dicarboxylic acids were different, were prepared. Using varnishes No. C1 to No. C3 thus prepared, insulated electric wires were fabricated and the permittivity of each of the insulated electric wires was measured. Results of measurement are shown in Table 3 together with the compositions of the blends. Further, a relation between the molecular weight of each dicarboxylic acid used and the permittivity is shown in FIG. 3.

TABLE 3

| No | | | C1 | C2 | C3 |
|---|---|---|---|---|---|
| Monomer (g) | Carboxylic Acid | Trimellitic Anhydride | 196 | 182 | 194 |
| | | Terephthalic Acid | 179 | 0 | 0 |
| | | Naphthalenedicarboxylic Acid | 0 | 218 | 0 |
| | | Alicyclic Terephthalic Acid | 0 | 0 | 184 |
| | Diamine | MDA | 101 | 94 | 100 |
| | Alcohol | Ethylene Glycol | 97 | 90 | 96 |
| | | THEIC | 253 | 236 | 251 |

| | | | | |
|---|---|---|---|---|
| Parameter | OH/COOH | 1.9 | 1.9 | 1.9 |
| | Imide/Ester | 0.32 | 0.32 | 0.32 |
| | THEIC/EG | 0.93 | 0.93 | 0.93 |
| Evaluation | Permittivity (ε) | 3.62 | 3.39 | 3.49 |

No. C1 corresponds to a conventional polyester imide resin based varnish in which terephthalic acid was used as the dicarboxylic acid and MDA was used as the diamine compound. As understood from Table 3 and FIG. 3, as the molecular weight of the dicarboxylic acid was increased, the permittivity was decreased. As with the diamine compound, it is considered that the permittivity can be decreased by using a dicarboxylic acid having a large molecular weight.

(3) Relation between Permittivity and Effect Provided by Using Diamine Compound and Dicarboxylic Acid Each Having Large Molecular Weight

(Preparation of Polyester Imide Resin Varnish (AC Series) and Fabrication and Evaluation of Insulated Electric Wire)

As the dicarboxylic acid, any one of the followings was used: terephthalic acid (molecular weight of 166: Mitsubishi Gas Chemical Company, Inc.); 2,6-naphthalenedicarboxylic acid (molecular weight of 216: Sumikin Air Water Inc.); and 1,4-cyclohexanedicarboxylic acid (molecular weight of 172: Nikko Rica Corporation), each of which was used in the C series. As the diamine, any of the followings was used: MDA (Mw=198.26); 2,2-bis(4(4-aminophenoxy)phenyl propane) (Mw=410.51); and 9,9′-bis(4-aminophenyl)fluorene (Mw=348.44). They were respectively added by amounts (g) shown in Table 4, together with the other raw material monomers (trimellitic anhydride, ethylene glycol, and THEIC). Further, as a catalyst, tetrapropyl titanate (TPT) was blended by 1.2 g. Then, temperature was increased to 80° C., then was increased from 80° C. to 180° C. in 1 hour, then was increased from 180° C. to 235° C. in 4 hours, and then was kept at 235° C. for 3 hours.

Each of them was blended to finally obtain 750 g of resin by calculating an amount allowing for values, shown in Table 4, of THEIC/EG (molar ratio of OH groups) and excess hydroxyl group ratio (OH/COOH) in the blended monomers, and a molar ratio (imide/ester) between imide bonds and ester bonds contained in the polyester imide resin to be synthesized.

It should be noted that as with the varnish C series, completion of the reaction was confirmed by confirming that the stoichiometric amount of water calculated from the amount of the blended monomers coincided with an amount of water generated in the synthesis of the polyester imide resin.

As with the varnish C series, the polyester imide resin synthesized as above was diluted. Further, a curing agent (TPT/cresol solution (TPT concentration of 63%)) and a phenol modified xylene formaldehyde resin P100 were added. Stirring was performed at 70° C. for approximately 1 hour. In this way, AC series polyester imide resin based varnishes No. AC1 to No. AC8 were prepared in which the types of the blended dicarboxylic acids and diamine compounds were different. Each of varnishes No. AC1 and No. AC2 corresponds to a conventional polyester imide resin based varnish in which terephthalic acid was used as the dicarboxylic acid and MDA was used as the diamine compound.

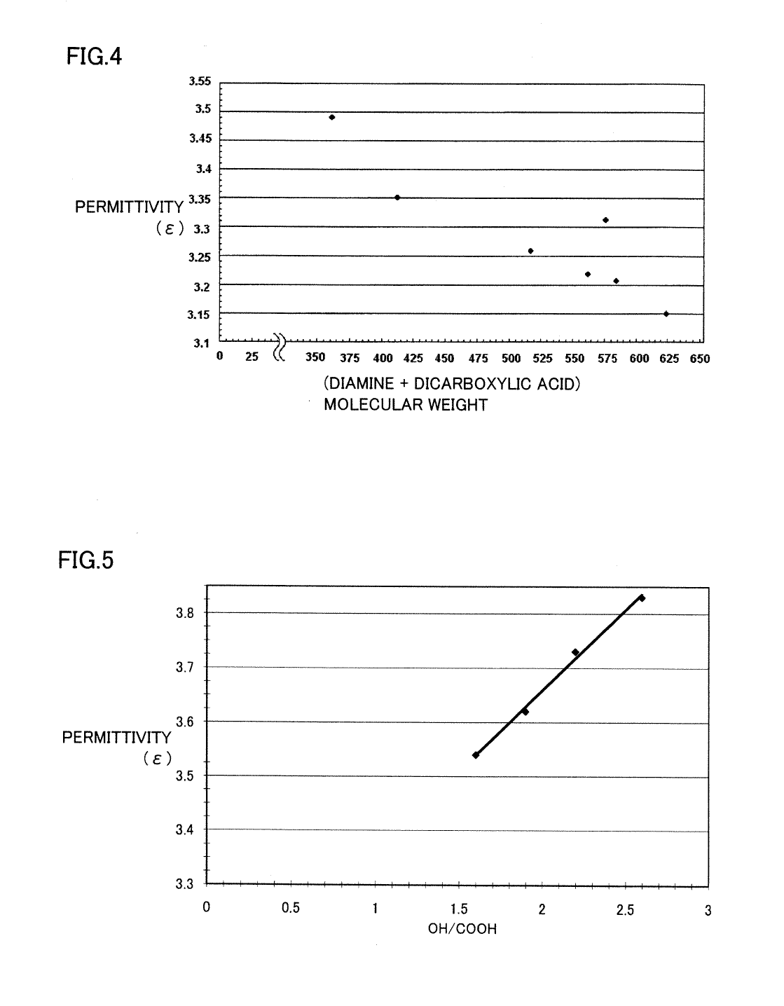

Using varnishes No. AC1 to No. AC8 thus prepared, insulated electric wires were fabricated by means of the above-described method, and the permittivity of each of the insulated electric wires was measured. Results of measurement are shown in Table 4 together with the blend compositions. It should be noted that “(Diamine+Dicarboxylic Acid) Molecular Weight” in Table 4 refers to a calculated total molecular weight of the respective molecular weights of the diamine compound and dicarboxylic acid used here. A relation between this total molecular weight and the permittivity is shown in FIG. 4.

TABLE 4

| No | | | AC1 | AC2 | AC3 | AC4 | AC5 | AC6 | AC7 | AC8 |
|---|---|---|---|---|---|---|---|---|---|---|
| Monomer (g) | Carboxylic Acid | Trimellitic Anhydride | 196 | 347 | 278 | 338 | 271 | 287 | 275 | 293 |
| | | Terephthalic Acid | 179 | 64 | 51 | 0 | 0 | 0 | 0 | 0 |
| | | Naphthalenedicarboxylic Acid | 0 | 0 | 0 | 81 | 65 | 69 | 0 | 0 |
| | | Cyclohexanedicarboxylic Acid | 0 | 0 | 0 | 0 | 0 | 0 | 53 | 56 |
| | Diamine | MDA | 101 | 179 | 0 | 174 | 0 | 0 | 0 | 0 |
| | | BAPP | 0 | 0 | 295 | 0 | 289 | 0 | 294 | 0 |
| | | BAPF | 0 | 0 | 0 | 0 | 0 | 261 | 0 | 266 |
| | Alcohol | Ethylene Glycol | 97 | 66 | 53 | 65 | 52 | 55 | 53 | 56 |
| | | THEIC | 253 | 173 | 138 | 169 | 135 | 143 | 137 | 146 |

| | | | | | | | | | |
|---|---|---|---|---|---|---|---|---|---|
| Parameter | OH/COOH | 1.9 | 1.6 | 1.6 | 1.6 | 1.6 | 1.6 | 1.6 | 1.6 |
| | Imide/Ester | 0.32 | 0.7 | 0.7 | 0.7 | 0.7 | 0.7 | 0.7 | 0.7 |
| | THEIC/EG | 0.93 | 0.93 | 0.93 | 0.93 | 0.93 | 0.93 | 0.93 | 0.93 |
| | (Diamine + Dicarboxylic Acid) Molecular Weight | 364.26 | 364.26 | 576.5 | 414.26 | 626.5 | 564.4 | 582.5 | 520.4 |
| Evaluation | Permittivity (ε) | 3.62 | 3.49 | 3.32 | 3.35 | 3.15 | 3.22 | 3.21 | 3.26 |

*BAPP: 2,2-bis{4-(4-aminophenoxy)phenyl}propane
*BAPF: 9,9′-bis(4-aminophenyl)fluorene

As understood from Table 4 and FIG. 4, as the total molecular weight was increased, the permittivity was decreased. Thus, by using a diamine compound and a dicarboxylic acid both having molecular weights larger than those of generally used terephthalic acid and MDA respectively, the content of imide groups per polyester imide chain can be made small and accordingly the permittivity can be decreased. Regarding the effect of contributing to the reduction of the permittivity, the diamine compound and the dicarboxylic acid do not hinder each other and contributes to the reduction of the content of imide groups per polyester imide chain due to the increased molecular weights. Further, AC3, AC7, and AC6 have similar (diamine+dicarboxylic acid) molecular weights, but the effect of reducing the permittivity in AC3 was smaller than those in AC6 and AC7. From this fact, it is understood that the effect of reducing the permittivity becomes larger by using a dicarboxylic acid and a diamine compound both having large molecular weights, as compared with a case of using only a diamine compound having a large molecular weight.

Thus, by using a diamine compound and a dicarboxylic acid both having molecular weights larger than those of generally used terephthalic acid and MDA respectively, a permittivity of 3.3 or less or a permittivity of 3.2 or less can be achieved, each of which is normally difficult to achieve when using only one of a dicarboxylic acid and a diamine compound containing no fluorine atoms.

From a comparison between AC1 and AC2, it is understood that the permittivity can be made low by decreasing the excess hydroxyl group ratio.

[Relation between Excess Hydroxyl Group Ratio and Permittivity]

(Preparation of Polyester Imide Resin (OH Series) and Fabrication and Evaluation of Insulated Electric Wire)

As the polyester imide components, trimellitic anhydride (TMA), terephthalic acid (TPA), 4,4′-diaminodiphenylmethane (MDA), ethylene glycol (EG), and tris(2-hydroxyethyl)cyanurate (THEIC) were blended by amounts (g) shown in Table 5. In addition, as a catalyst, tetrapropyl titanate (TPT) was blended by 1.2 g. Thereafter, temperature was increased to 80° C., then was further increased from 80° C. to 180° C. in 1 hour, then was further increased from 180° C. to 235° C. in 4 hours, and then was kept at 235° C. for 3 hours.

THEIC/EG (molar ratio of OH groups) and excess hydroxyl group ratio (OH/COOH) in the blended monomers, as well as a molar ratio (imide/ester) between imide bonds and ester bonds contained in the polyester imide resin to be synthesized were as shown in Table 5.

The polyester imide resin synthesized as described above was diluted to attain a polyester imide resin concentration of 50 mass % by adding a solution in which SCX-1 (product name of Neo Chemical Co., Ltd.; mixed solvent of phenol and cresol) and Swasol #1000 (product name of Maruzen Petrochemical Co., Ltd.; solvent naphtha) were mixed at a ratio of SCX-1/Swasol=80/20.

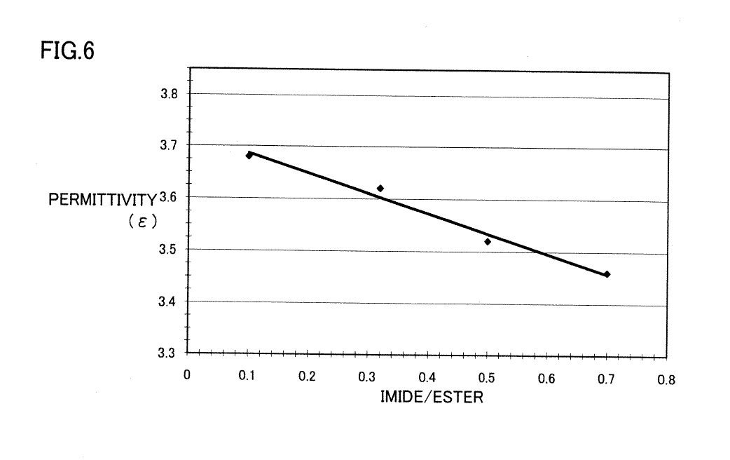

To the polyester imide resin solution synthesized as above, a TPT/cresol solution (TPT concentration of 63%) obtained by dissolving TPT (tetrapropyl titanate) with cresol was added as a curing agent by an amount shown in Table 5. Thereafter, they were mixed at 120° C. for 2 hours. Next, as another resin, phenol modified xylene formaldehyde resin P100 in a solid state was dissolved with an organic solvent SCX-1 (product name of Neo Chemical Co., Ltd.; mixed solvent of phenol and cresol), and the resulting solution was added by an amount shown in Table 5. Thereafter, stirring was performed at 70° C. for approximately 1 hour. In this way, polyester imide resin based varnishes No. OH1 to No. OH7 were prepared. Using polyester imide resin based varnishes OH1 to OH7 thus prepared, insulated electric wires were fabricated and permittivity of each of the insulated electric wires was measured based on the above-described measurement method. Results of measurement are shown in Table 5 together with the compositions of the polyester imides. Further, a relation between the excess hydroxyl group ratio and the permittivity (each of No. OH1 to No. OH4) is shown in FIG. 5, and a relation between the imide/ester ratio and the permittivity (Nos. OH2, OH5, OH6, and OH7) is shown in FIG. 6.

TABLE 5

| No | | OH1 | OH2 | OH3 | OH4 | OH5 | OH6 | OH7 |
|---|---|---|---|---|---|---|---|---|
| Raw Material | TMA | 213 | 196 | 184 | 169 | 73 | 268 | 327 |
| Monomer (g) | TPA | 195 | 179 | 168 | 154 | 294 | 117 | 60 |
| | MDA | 110 | 101 | 95 | 87 | 37 | 138 | 169 |
| | EG | 89 | 97 | 105 | 114 | 120 | 85 | 74 |
| | THEIC | 232 | 253 | 276 | 299 | 313 | 223 | 194 |
| Parameter | OH/COOH | 1.6 | 1.9 | 2.2 | 2.6 | 1.9 | 1.9 | 1.9 |
| | Imide/Ester | 0.32 | 0.32 | 0.32 | 0.32 | 0.1 | 0.5 | 0.7 |
| | THEIC/EG | 0.93 | 0.93 | 0.93 | 0.93 | 0.93 | 0.93 | 0.93 |
| Additive | TPT/Cresol Solution *¹ | 61 | 60 | 61 | 61 | 61 | 60 | 60 |
| | Phenol Modified | 61 | 60 | 61 | 61 | 61 | 60 | 60 |
| | Formaldehyde Resin/SCX-1 | | | | | | | |
| | Solution*² | | | | | | | |

| | | | | | | | |
|---|---|---|---|---|---|---|---|
| Permittivity (ε) | 3.54 | 3.62 | 3.73 | 3.83 | 3.68 | 3.52 | 3.46 |

*¹ Amount of TPT-Cresol Mixed Liquid
*²Amount of 50% By Mass of P100 Solution

As understood from FIG. 5, with the imide/ester ratio being constant, the permittivity tends to be increased as the OH/COOH is increased. Thus, it is understood that in the case where phthalic acid is used as the dicarboxylic acid and MDA is used as the diamine, in order to reduce the permittivity to 3.7 or less, the OH/COOH needs to be 1.9 or less (see OH1, OH2, OHS, and OH6).

As understood from FIG. 6, with the OH/COOH being constant, the permittivity tends to be decreased as the imide/ester is increased. As understood from a comparison between OH2 and each of OH6 and OH7, by increasing the imide/ester ratio to, specifically, 0.32 or more, the permittivity can be further decreased without decreasing the OH/COOH.

### INDUSTRIAL APPLICABILITY

The polyester imide resin based varnish of the present invention is capable of forming a polyester imide film having low permittivity, and is therefore suitably usable for formation of an insulating coating film of an insulated electric wire fed with high applied voltage.

1. A polyester imide resin based varnish for a low-permittivity coating film, mainly comprising a polyester imide resin obtained by reacting a carboxylic acid or derivative thereof that is a carboxylic acid including a dicarboxylic acid, or an anhydride or alkyl ester thereof; an alcohol; and a diamine compound with one another, wherein
monomer composition is adjusted such that a total molecular weight of said diamine compound and said dicarboxylic acid becomes 368 or more, or a molar ratio (OH/COOH) of a hydroxyl group of said alcohol to a carboxyl group of said carboxylic acid or derivative thereof becomes 1.9 or less.

2. The polyester imide resin based varnish for the low-permittivity coating film according to claim 1, wherein said carboxylic acid or derivative thereof includes a dicarboxylic acid having a molecular weight of 167 or more, or an anhydride or alkyl ester thereof.

3. The polyester imide resin based varnish for the low-permittivity coating film according to claim 1, wherein said diamine compound includes a diamine compound having a molecular weight of 250 or more.

4. The polyester imide resin based varnish for the low-permittivity coating film according to claim 1, wherein said carboxylic acid or derivative thereof includes a dicarboxylic acid having a molecular weight of 167 or more, or an anhydride or alkyl ester thereof, and said diamine compound includes a diamine compound having a molecular weight of 250 or more.

5. The polyester imide resin based varnish for the low-permittivity coating film according to claim 2, wherein said dicarboxylic acid is naphthalenedicarboxylic acid or cyclohexanedicarboxylic acid.

6. The polyester imide resin based varnish for the low-permittivity coating film according to claim 3, wherein said diamine compound is a diamine compound containing no fluorine atom.

7. The polyester imide resin based varnish for the low-permittivity coating film according to claim 1, wherein a molar ratio (OH/COOH) of a hydroxyl group of said alcohol to a carboxyl group of said carboxylic acid or derivative thereof is 1.2 to 2.7.

8. The polyester imide resin based varnish for the low-permittivity coating film according to claim 1, wherein a ratio (imide/ester) of a content of an imide acid portion to a content of an ester portion is 0.2 to 1.0.

9. A polyester imide resin based varnish for a low-permittivity coating film, mainly comprising a polyester imide resin obtained by reacting a carboxylic acid or derivative thereof that is a carboxylic acid including a dicarboxylic acid, or an anhydride or alkyl ester thereof; an alcohol; and a diamine compound with one another, wherein
monomer composition is adjusted such that a molar ratio (OH/COOH) of a hydroxyl group of said alcohol to a carboxyl group of said carboxylic acid or derivative thereof becomes 1.9 or less.

10. The polyester imide resin based varnish for the low-permittivity coating film according to claim 9, wherein a ratio (imide/ester) of a content of an imide acid portion to a content of an ester portion is 0.32 or more.

11. The polyester imide resin based varnish for the low-permittivity coating film according to claim 9, wherein said alcohol is a mixed alcohol containing ethylene glycol (EG) and tris(2-hydroxyethyl)isocyanurate (THEIC) at a ratio of THIEC/EG=0.5 to 4.0.

12. The polyester imide resin based varnish for the low-permittivity coating film according to claim 1, further comprising a phenol resin or analog thereof.

13. An insulated electric wire comprising an insulating coating film obtained by applying the varnish recited in claim 1 onto a conductor and baking the varnish.

14. The polyester imide resin based varnish for the low-permittivity coating film according to claim 4, wherein said dicarboxylic acid is naphthalenedicarboxylic acid or cyclohexanedicarboxylic acid.

15. The polyester imide resin based varnish for the low-permittivity coating film according to claim 4, wherein said diamine compound is a diamine compound containing no fluorine atom.

16. The polyester imide resin based varnish for the low-permittivity coating film according to claim 10, wherein said alcohol is a mixed alcohol containing ethylene glycol (EG) and tris(2-hydroxyethyl)isocyanurate (THEIC) at a ratio of THIEC/EG=0.5 to 4.0.

17. The polyester imide resin based varnish for the low-permittivity coating film according to claim 11, further comprising a phenol resin or analog thereof.

18. An insulated electric wire comprising an insulating coating film obtained by applying the varnish recited in claim 11 onto a conductor and baking the varnish.
